(19) United States
(12) Patent Application Publication
(10) Pub. No.: US 2024/0330862 A1
(43) Pub. Date: Oct. 3, 2024

(54) Connected Configurations Across Collaborator Accounts

(71) Applicant: Procore Technologies, Inc., Carpinteria, CA (US)

(72) Inventors: John Tuley, Lyons, CO (US); Robert Farr, Lathrop, MO (US); Nick Tilden, Austin, TX (US); Reza Shirazi, Austin, TX (US)

(21) Appl. No.: 18/193,627

(22) Filed: Mar. 30, 2023

(51) Int. Cl. G06Q 10/10

(52) U.S. Cl. CPC G06Q 10/103

(57) ABSTRACT

An example computing platform is configured to (i) receive, from a first end-user device, a prime configuration for at least one type of data object related to a construction project, (ii) cause all data objects of the at least one type to be created in accordance with at least the prime configuration, (iii) receive, from a second end-user device, an extension to the prime configuration for the at least one type of data object, and (iv) after receiving the extension to the prime configuration, (a) cause a given data object of the at least one type to be displayed via the second end-user device in accordance with the prime configuration and the extension to the prime configuration, and (b) cause the given data object to be displayed via the first end-user device in accordance with the prime configuration but not the extension to the prime configuration.

### BACKGROUND

Construction projects can be complex and demanding undertakings that involve intensive planning, design, and implementation throughout several discrete phases. A construction project often involves numerous different parties including project towners, general contractors, subcontractors, vendors, architects, engineers, suppliers, etc., who are each responsible for managing certain aspects of a construction project and/or performing various project-related tasks in order to help complete the construction project. Construction projects also involve a vast amount of project-related data that needs to be tracked and made accessible to the different parties in order to complete project-related tasks. Completing project-related tasks often requires coordination, communication, and collaboration between the different parties involved in a construction project, which can be difficult to manage effectively and efficiently.

Accordingly, software technology that helps to facilitate electronic collaboration between parties that are responsible for completing work related to a construction project is desirable.

### OVERVIEW

As mentioned above, construction projects can be very complex, involving several different project phases and relying heavily on successful collaboration between many different parties in order to achieve successful completion. For instance, a construction project can involve a large number of companies that are each responsible for handling certain aspects of the construction project, and each company may have one or more construction professionals and/or teams of construction professionals that are responsible for completing certain project-related tasks.

Many, if not all, of the tasks related to a construction project require some extent of collaboration between the different parties. For instance, parties need to be able to communicate with other parties (inter-party communication) to complete actions related to work for the construction project, such as requesting and exchanging information required to complete tasks (e.g., via a Request for Information (RFI) etc.), updating task progress, scheduling tasks, or exchanging accounting information (e.g., invoices, payment, etc.), among other possibilities. Further, parties need to be able to communicate internally (intra-party communication) to carry out actions related to their respective responsibilities for the construction project (e.g., deploy a team to an on-site location to complete a task, etc.).

In general, the construction industry as a whole is susceptible to various inefficiencies related to processing, managing, handling, and establishing connectivity between the vast amounts of data typically associated with construction projects. Frequently, these inefficiencies stem from the siloed structure of construction project data, which typically lacks unifying characteristics that can serve as common denominators to provide meaningful connectivity between construction project data.

To alleviate some of the burdens associated with cross-party collaboration, software technology has been developed to facilitate electronic collaboration between multiple parties. In particular, Procore Technologies, Inc., who is the assignee of the present application, has been developing new software technology for facilitating ingestion, storage, and accessibility of project data, determining intelligent connectivity between project data, and deriving meaningful insights from project data, as well as new frameworks and software tools for improved cross-party collaboration.

For example, Procore Technologies has developed software technology that includes an improved data management and cross-party collaboration model that provides collaborators with their own user accounts and more flexible data access and data retention permissions with respect to construction project data. More information about these improvements can be found in U.S. application Ser. No. 17/191,484, filed on Mar. 3, 2021, and titled “Computer System and Methods for Managing Data, Data Access, and Data Retention,” which is incorporated by reference herein in its entirety.

As another example, Procore Technologies has developed software technology that utilizes machine-learning models to ingest data that is generated throughout different phases of a construction project and associate that data with physical locations within the construction project. Based on these associations, relationships between data objects can be established and used to create a construction knowledge graph that reflects the connectivity between the various different types of data objects associated with a construction project. More information about these improvements can be found in U.S. application Ser. No. 17/307,869, filed on May 4, 2021, and titled “Construction Knowledge Graph,” which is incorporated by reference herein in its entirety.

As yet another example, Procore Technologies has developed new software technology that utilizes machine-learning models to identify discrete physical locations of a construction project, determine interrelationships between those physical locations and other data associated with the construction project, and generate a hierarchical data taxonomy that presents those location entities and their interrelationships in a visual depiction based on which the location entities and their interrelationships can be easily identified. More information about these improvements can be found in U.S. application Ser. No. 17/957,501, filed on Sep. 30, 2022, and titled “Computer Systems and Methods for Identifying Location Entities and Generating a Location Entity Data Taxonomy,” which is incorporated by reference herein in its entirety.

Procore Technologies has continued to build upon these innovations by exploring improvements related to collaborative processes and data connectivity.

Nonetheless, existing technology for cross-party collaboration does not address certain challenges, particularly with respect to reconciling different parties' respective needs for customizing project data. In this regard, each party involved in a construction project typically has different preferences for customizing project data based on that party's individual needs and responsibilities. For example, each party may have different preferences with respect to how project data is identified, the format in which the data is expressed, or how workflows for completing certain tasks are defined, among other possibilities.

For instance, a first collaborator working on a construction project may prefer that given project data is described (e.g., labeled) in accordance with a first format that provides baseline identifying information about the given project data, whereas a second collaborator may prefer that the same project data is described in accordance with a second format that provides more detailed information relevant to the second collaborator's task and is thus more useful for the second collaborator and its construction crews. However, enabling different parties to label the same project data in different ways based on their individual preferences can lead to data incompatibility when the two parties attempt to collaborate with each other. For example, the first formatting of the project data is not specific enough to be useful to the second collaborator, and the second formatting of the project data may not match the format that is expected by the first party, and thus the underlying project data may not be recognized. Inconsistencies such as these in how project data is stored, presented, or utilized can also hinder attempts to extract insights from the project data. Further, these types of data inconsistencies can lead to adverse consequences, such as miscommunications and/or uninformed decision-making as a result of relying on inaccurate data, which in turn may jeopardize the successful and timely completion of a construction project.

In view of these and other considerations, disclosed herein is new software technology that facilitates enhanced collaborative processes by improving data compatibility among parties collaborating on a construction project, while also providing collaborators with flexibility to customize project data according to their own respective preferences.

Accordingly, in one aspect, disclosed herein is a method carried out by a computing platform that involves (i) receiving, from a first end-user device associated with a first user account, a prime configuration for at least one type of data object related to a construction project, (ii) causing all data objects of the at least one type of data object related to the construction project to be created in accordance with at least the prime configuration, (iii) receiving, from a second end-user device associated with a second user account, an extension to the prime configuration for the at least one type of data object, and (iv) after receiving, from the second end-user device, the extension to the prime configuration, (a) causing a given data object of the at least one type of data object to be displayed via the second end-user device in accordance with the prime configuration and the extension to the prime configuration, and (b) causing the given data object to be displayed via the first end-user device in accordance with the prime configuration but not the extension to the prime configuration.

In another aspect, disclosed herein is a computing platform comprising at least one network interface, at least one processor, at least one non-transitory computer-readable medium, and program instructions stored on the at least one non-transitory computer-readable medium that are executable by the at least one processors such that the computing platform is configured to carry out the functions disclosed herein, including but not limited to the functions of the foregoing method.

In yet another aspect, disclosed herein is at least one non-transitory computer-readable storage medium that is provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments disclosed herein may be implemented.

FIG. 2 depicts a structural diagram of an example computing platform that may be configured to carry out one or more functions in accordance with the disclosed technology.

FIG. 3 depicts a structural diagram of an example end-user device that may be configured to communicate with the example computing platform of FIG. 2 and also carry out one or more functions in accordance with the disclosed technology.

FIG. 4 depicts a schematic diagram of a hierarchy of collaborators on a construction project and their associated configurations.

FIG. 5 depicts an example data object as viewed by three different collaborators having different configuration settings.

FIG. 6 depicts an example flowchart that may be carried out to facilitate collaboration across user accounts.

FIG. 7 depicts an example workflow for a data object that is acted on by three different collaborators.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

In practice, as one possible implementation, the disclosed software technology may be provided to customers via a construction management software application in the form of a software as a service (“SaaS”) and may include both front-end software running on one or more end-user devices that are accessible to users of the software technology and back-end software running on a back-end computing platform (sometimes referred to as a “cloud” platform or a “data” platform) that interacts with and/or drives the front-end software, and which may be operated (either directly or indirectly) by a provider of the front-end client software (e.g., Procore Technologies, Inc.). As another possible implementation, the disclosed software technology may include front-end client software that runs on end-user devices without interaction with a back-end platform (e.g., a native software application, a mobile application, etc.). The software technology disclosed herein may take other forms as well.

### I. EXAMPLE NETWORK CONFIGURATION

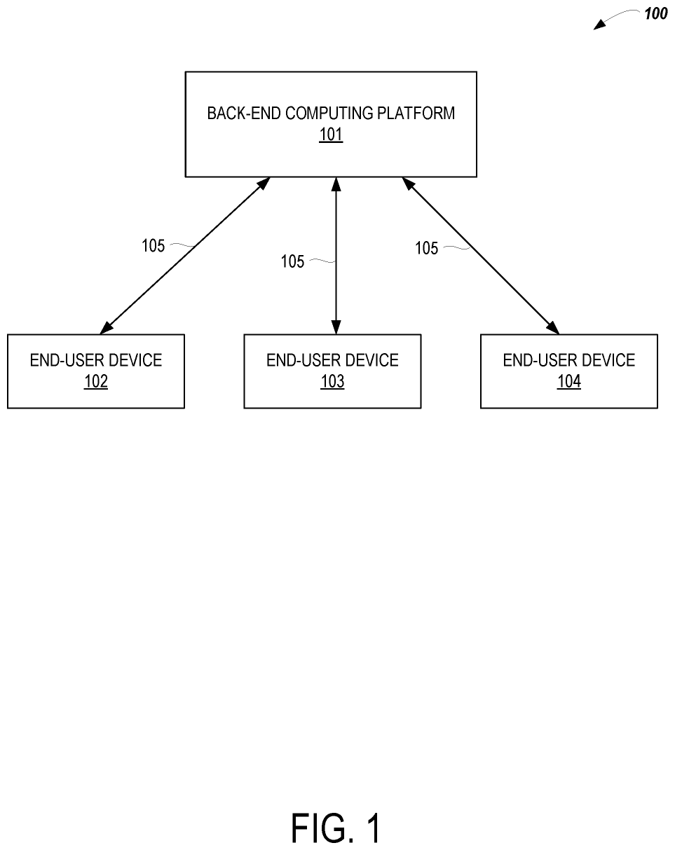

Turning now to the figures, FIG. 1 depicts an example network configuration 100 in which example embodiments of the present disclosure may be implemented. As shown in FIG. 1, the network configuration 100 includes an example back-end computing platform 102 that may be communicatively coupled to one or more end-user devices, depicted here, for the sake of discussion, as three end-user devices 112.

In practice, the back-end computing platform 102 may generally comprise some set of physical computing resources (e.g., processors, data storage, communication interfaces, etc.) that are utilized to implement the new software technology discussed herein. This set of physical computing resources may take any of various forms. As one possibility, the back-end computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the back-end computing platform 102 may comprise “on-premises” computing resources of the organization that operates the back-end computing platform 102 (e.g., organization-owned servers). As yet another possibility, the back-end computing platform 102 may comprise a combination of cloud computing resources and on-premises computing resources.

Further, as yet another possibility, the back-end computing platform 102 may comprise one or more dedicated servers have been provisioned with software for carrying out one or more of the computing platform functions disclosed herein, including but not limited to functions related to determining relationships between project data, construction projects, and/or parties associated with construction projects, determining a standardized data scheme that can be used to organize information about project data, construction projects, and/or parties associated with construction projects, or causing the information about project data, construction projects, and/or parties associated with construction projects, to be presented by the one or more end-user devices 112. The one or more computing systems of the back-end computing platform 102 may take various other forms and be arranged in various other manners as well.

In turn, end-user devices 112 may take any of various forms, examples of which may include a desktop computer, a laptop, a netbook, a tablet, a smartphone, and/or a personal digital assistant (PDA), among other possibilities.

As further depicted in FIG. 1, the back-end computing platform 102 may be configured to communicate with the end-user devices 112 over respective communication paths. Each communication path between the back-end computing platform 102 and an end-user device 112 may generally comprise one or more communication networks and/or communications links, which may take any of various forms. For instance, each respective communication path with the back-end computing platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path with the back-end computing platform 102 may be wireless, wired, or some combination thereof, and may carry data according to any of various different communication protocols. Although not shown, the respective communication paths with the back-end computing platform 102 may also include one or more intermediate systems. For example, it is possible that the back-end computing platform 102 may communicate with a given end-user device 112 via one or more intermediary systems, such as a host server (not shown). Many other configurations are also possible.

Although not shown in FIG. 1, the back-end computing platform 102 may also be configured to receive data from one or more external data sources that may be used to facilitate functions related to the processes disclosed herein. For example, the back-end computing platform 102 may be configured to receive project data from external data sources and determine relationships for that project data.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. EXAMPLE COMPUTING DEVICES

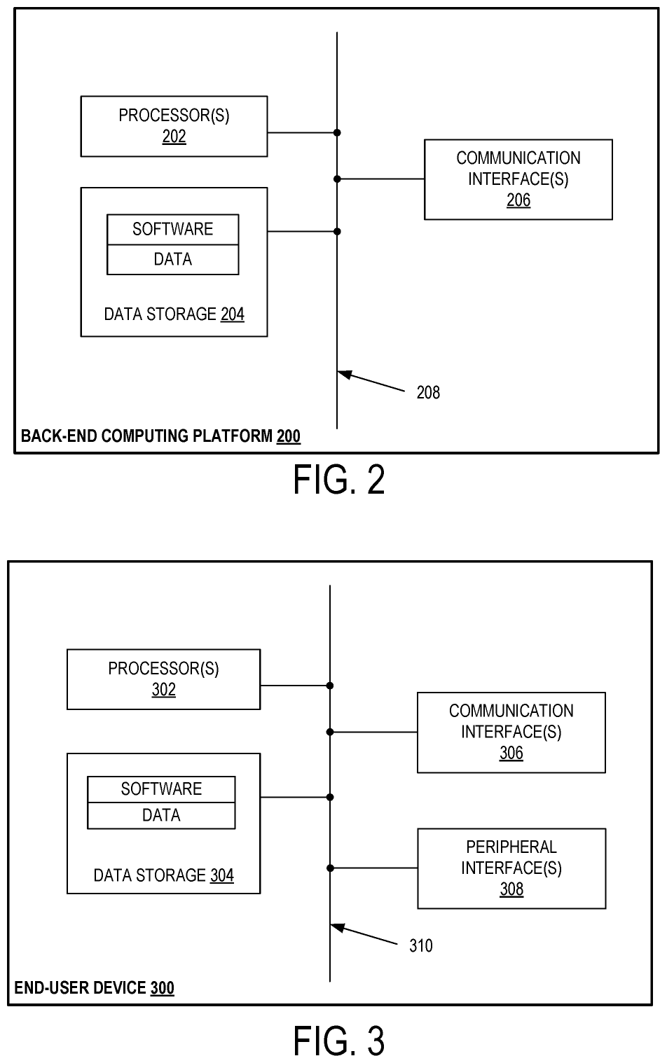

FIG. 2 is a simplified block diagram illustrating some structural components that may be included in an example computing platform 200. The example computing platform 200 could serve as, for instance, the back-end computing platform 102 of FIG. 1 that may be configured to create and/or run the disclosed software technology. In line with the discussion above, the computing platform 200 may generally comprise one or more computer systems (e.g., one or more servers), and these one or more computer systems may collectively include at least one or more processors 202, a data storage 204, and one or more communication interfaces 206, all of which may be communicatively linked by a communication link 208 that may take the form of a system bus, a communication network such as a public, private, or hybrid cloud, or some other connection mechanism.

The one or more processors 202 may comprise one or more processor components, such as general-purpose processors (e.g., one or more single- or multi-core microprocessors), special-purpose processors (e.g., one or more application-specific integrated circuits or digital-signal processors), programmable logic devices (e.g., one or more field programmable gate arrays), controllers (e.g., one or more microcontrollers), and/or any other processor components now known or later developed. In line with the discussion above, it should also be understood that the one or more processors 202 could comprise processing components that are distributed across a plurality of physical computing resources connected via a network, such as a computing cluster of a public, private, or hybrid cloud.

In turn, the data storage 204 may comprise one or more non-transitory computer-readable storage mediums that are collectively configured to store (i) program instructions that are executable by the one or more processors 202 such that the computing platform 200 is configured to perform some or all of the functions disclosed herein and (ii) data that may be received, derived, or otherwise stored, for example, in one or more databases, file systems, or the like, by the computing platform 200 in connection with the disclosed functions. In this respect, the one or more non-transitory computer-readable storage mediums of the data storage 204 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 204 may comprise computer-readable storage mediums that are distributed across a plurality of physical computing resources connected via a network, such as a storage cluster of a public, private, or hybrid cloud. Data storage 204 may take other forms and/or store data in other manners as well.

The one or more communication interfaces 206 may be configured to facilitate wireless and/or wired communication with external data sources and/or end-user devices, such as the end-user devices 112 in FIG. 1. Additionally, in an implementation where the back-end computing platform 200 comprises a plurality of physical computing resources connected via a network, the one or more communication interfaces 206 may be configured to facilitate wireless and/or wired communication between those physical computing resources (e.g., between computing and storage clusters in a cloud network). As such, the one or more communication interfaces 206 may take any suitable form for carrying out these functions, examples of which may include an Ethernet interface, a serial bus interface (e.g., Firewire, USB 3.0, etc.), a chipset and antenna adapted to facilitate wireless communication and/or any other interface that provides for wireless communication (e.g., Wi-Fi communication, cellular communication, short-range wireless protocols, etc.) and/or wired communication, among other possibilities. The one or more communication interfaces 206 may also include multiple communication interfaces of different types. Other configurations are possible as well.

Although not shown, the computing platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the back-end computing platform 200.

It should be understood that the back-end computing platform 200 is one example of a computing platform that may be used with the embodiments described herein. Numerous other arrangements are possible and contemplated herein. For instance, other computing platforms may include additional components not pictured and/or more or less of the pictured components.

Turning now to FIG. 3, a simplified block diagram is provided to illustrate some structural components that may be included in an example end-user device 300, such as an end-user device 112 described above with reference to FIG. 1. As shown in FIG. 3, the end-user device 300 may include one or more processors 302, data storage 304, one or more communication interfaces 306, and one or more peripheral interfaces 308, all of which may be communicatively linked by a communication link 810 that may take the form of a system bus or some other connection mechanism. Each of these components may take various forms.

The one or more processors 302 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

The data storage 304 may comprise one or more non-transitory computer-readable storage mediums that are collectively configured to store (i) program instructions that are executable by the processor(s) 302 such that the end-user device 300 is configured to perform certain functions related to interacting with and accessing services provided by a computing platform, such as the example back-end computing platform 200 described above with reference to FIG. 2, and (ii) data that may be received, derived, or otherwise stored, for example, in one or more databases, file systems, repositories, or the like, by the end-user device 300, related to interacting with and accessing the services provided by the computing platform. In this respect, the one or more non-transitory computer-readable storage mediums of the data storage 304 may take various forms, examples of which may include volatile storage mediums such as random-access memory, registers, cache, etc., and non-volatile storage mediums such as read-only memory, a hard-disk drive, a solid-state drive, flash memory, an optical-storage device etc. The data storage 304 may take other forms and/or store data in other manners as well.

The one or more communication interfaces 306 may be configured to facilitate wireless and/or wired communication with other computing devices. The one or more communication interfaces 306 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The end-user device 300 may additionally include or have one or more peripheral interfaces for connecting to an electronic peripheral that facilitate user interaction with the end-user device 300, such as a keyboard, a mouse, a trackpad, a display screen, a touch-sensitive interface, a stylus, a virtual-reality headset, and/or one or more speaker components, among other possibilities.

It should be understood that the end-user device 300 is one example of an end-user device that may be used to interact with a computing platform as described herein. Numerous other arrangements are possible and contemplated herein. For instance, in other embodiments, the end-user device 300 may include additional components not pictured and/or more or fewer of the pictured components.

### III. EXAMPLE FUNCTIONALITY

As described above, Procore Technologies has continued to develop software technology related to improved collaboration models and techniques for improving data connectivity. Disclosed herein is new software technology that provides new approaches for improving the compatibility of various types of construction data across collaborative processes, while still providing individual collaborators with flexibility to separately customize how the construction data is represented within their own respective user accounts.

In this respect, and in accordance with the new approaches discussed herein, each party that is involved in a construction project may have (or may register for) a user account for a software application that incorporates the disclosed software technology, such as the construction management software application provided by Procore Technologies. For instance, each project owner, general contractor, and subcontractor may have a respective user account via which each party can manage their respective responsibilities for a construction project and perform various actions such as accessing information about their connected construction projects and project data for those construction projects, or communicating and coordinating with other parties to complete work for the construction project, among other possibilities.

In line with the discussion above, successfully completing a construction project often requires multiple parties to communicate and coordinate with each other to complete various project-related tasks. The various parties involved in a construction project typically involve a hierarchy of contractual relationships between a project owner, a general contractor, numerous subcontractors, vendors, suppliers, and the like. Within this hierarchy, the project owner is typically responsible for financing the construction project and typically hires a general contractor. The general contractor is typically responsible for managing the construction project, maintaining a schedule and budget for the construction project, and hiring and overseeing subcontractors to complete work for the construction project. Each subcontractor is typically responsible for completing one or more specific project tasks (e.g., procuring and/or installing materials, performing work, etc.), which may involve managing their own internal work crews and/or hiring additional sub-subcontractors, vendors, suppliers, etc. to assist them with performing the one or more particular project tasks, providing necessary materials, and so on. Within this hierarchy, a project owner or a general contractor may be referred to herein as a “prime” party that has a higher level of responsibility and control over the construction project, while all parties that exchange data with each other, including the prime party, may be referred to herein as a “collaborator” party, or simply a “collaborator” for the purposes of the discussion below.

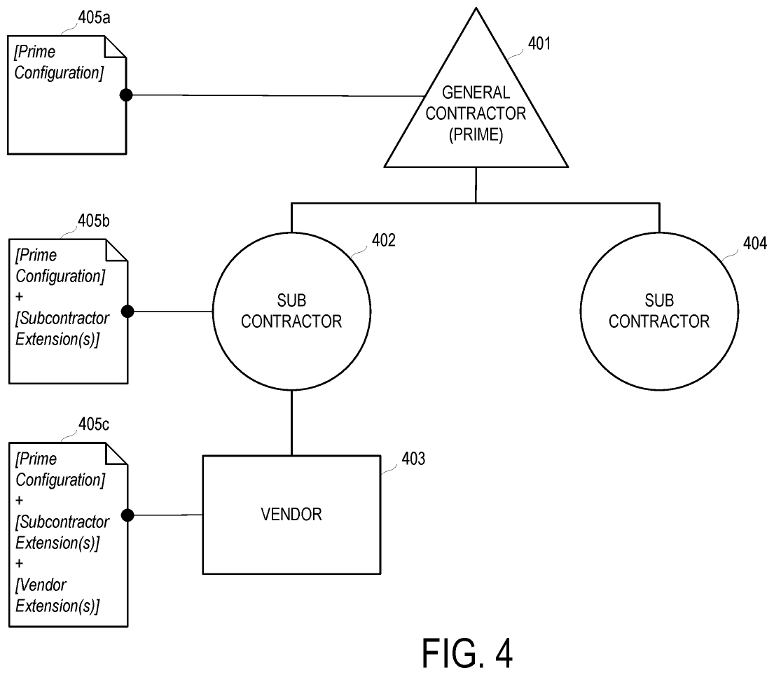

FIG. 4 depicts a schematic diagram of this type of hierarchy for an example construction project, including a general contractor 401, or prime party, at the highest level of the hierarchy. Below the general contractor 401 are two subcontractors 402 and 404, which, for the purposes of this disclosure are referred to as “downstream” collaborators of the general contractor. In turn, the general contractor 401 is an “upstream” collaborator of both the subcontractor 402 and the subcontractor 404. For example, the subcontractor 402 may handle work associated with a particular trade, e.g., glazing, and the subcontractor 404 may handle work associated with a different trade, such as plumbing. A vendor 403 is additionally shown in FIG. as a downstream collaborator of the subcontractor 402. For example, the vendor 403 may provide materials (e.g., glass for windows) to the glazing subcontractor 402. It will be appreciated that FIG. 4 represents a substantially simplified example of a hierarchy that might exist on a real construction project, which might involve dozens of subcontractors downstream of the general contractor 401, each of whom might have their own additional downstream collaborators including further sub-subcontractors, vendors, suppliers, etc.

As mentioned above, while some construction management software applications provide a convenient mechanism for engaging in some types of electronic collaboration, they generally do not address the problem of data incompatibility between collaborators who have a different schema for certain types of construction data, based on their own individual preferences. For example, this problem of data incompatibility may arise when two collaborators have different ways of referring to the same project data (e.g., a location on the construction project, a trade involved in the construction project), or use their own custom data fields when creating new data objects for the construction project. This incompatibility, in turn, can make it difficult for collaborators to be confident that they are talking about the same thing, which can frustrate the collaborative process and lead to negative outcomes for the construction project.

To address these issues, the approach discussed herein allows a prime party to establish a common way for collaborators to refer to data objects that may be shared during the course of a construction project, while still allowing individual collaborators to add their own customizations around the baseline that is established by the prime party. This baseline may be referred to herein as a prime configuration, and may encompass various different types of configuration information related to the underlying construction data.

As one example, a prime configuration may define a common framework and/or format for certain types of reference data, so that all collaborators have a common lexicon for referring to things that are referenced frequently. This type of reference data may take various forms.

As one possibility, a prime configuration may establish reference data that includes a project name or a project address that indicates the location of the construction project. In this regard, the name or address of the construction project site may be used to define, classify, or categorize other data, such as contracts, bids, purchase orders, etc., related to the construction project. Obscurity or inaccuracy of the project's name or address can adversely impact progress of the construction project, such as causing confusion about where materials should be shipped, among other possibilities.

As another possibility, a prime configuration may establish reference data that defines working days for the construction project—i.e., the days of the week on which work can be scheduled and expected to be performed (e.g., Monday through Friday, Monday through Thursday, etc.). Similarly, the prime configuration may also define working hours—i.e., hours of the day during which work is allowed to be performed (e.g., 9 am to 5 μm, 8 am to 6 pm, etc.). Working days and/or working hours can impact scheduling and budgeting for a construction project. For instance, if a certain task is expected to take 5 days or 40 hours, the defined working days for the construction project could impact decisions like when the task should be scheduled to begin, when the task should be scheduled to end, whether any days should be omitted from calculation of a due date, or whether additional construction professionals need to be added to a crew that is assigned to complete the task, as some examples. Obscurity or inaccuracy about the working days and/or working hours for the construction project can adversely impact progress of the construction project, such as causing confusion about when certain work should be performed, which can in turn cause project delays and increased costs.

As another possibility, a prime configuration may establish reference data that defines a date setting, such as a date format (YYYY-MM-DD, DD-MM-YYYY, MM-DD, YYYY, etc.), that should be applied when dates are shared within the construction project. Obscurity or inaccuracy about dates can adversely impact several aspects of the construction project, such as scheduling, which can in turn cause project delays and increased costs.

As another possibility, a prime configuration may establish reference data that defines a measurement system that should be applied to measurements associated with the construction project (e.g., imperial, metric). Obscurity or inaccuracy about measurements can adversely impact several aspects of the construction project, such as procurement of materials or the accurate installation of materials.

As another possibility, a prime configuration may establish reference data that includes a predefined list or hierarchy of trades that are involved in the construction project, such as carpentry, mechanical, electrical, HVAC, plumbing, etc. In this way, any project data that involves a reference to a trade must indicate one of the trades from the predefined list or hierarchy of trades in the prime configuration. Obscurity or inaccuracy about what trade is being referred to can adversely impact several aspects of the construction project, such as budgeting, procuring materials, or hiring subcontractors, as some examples, which can in turn cause project delays and increased costs.

As yet another possibility, a prime configuration may establish reference data that includes a default composition for one or more work breakdown structures that are to be applied to project data and/or a collaborative event that is shared between parties. More information about defining work breakdown structures can be found in U.S. Pat. No. 11,120,376, filed Apr. 25, 2019, and titled “Flexible Work Breakdown Structure,” which is incorporated by reference herein in its entirety. Obscurity or inaccuracy in work breakdown structures can adversely impact several aspects of the construction project, such as budgeting, invoicing, or timekeeping, as some examples, which can in turn cause project delays and increased costs.

As yet another possibility, a prime configuration may establish reference data that establishes a predefined hierarchy of location entities that correspond to discrete physical locations within the construction project (e.g., a given room, a given area, etc.). Further, the prime configuration may establish a respective location name for each location entity, which may help collaborators to be confident that they are referring to the same physical location within the construction project. Obscurity or inaccuracy about physical locations may adversely impact progress of the construction project, such as causing confusion about where certain work should be performed. Additional information about establishing a hierarchy of location entities can be found in U.S. application Ser. No. 17/957,501, which was incorporated by reference above.

Advantageously, reference data established in a prime configuration may serve to ensure that project data indicating certain types of information is described in a consistent way to each party that accesses the project data, thereby reducing, if not eliminating, data inconsistencies that may otherwise be introduced through user activity involving the project data (e.g., incorrectly tagging project data and thereby obscuring information about the project data as a result of conflicting collaborator customizations, etc.). Further, the reference data established in a prime configuration can serve as a building block upon which extensions to the prime configuration can be added, as discussed below.

The types of reference data that may be established in a prime configuration may also take various other forms.

A prime configuration may encompass other types of configurable data as well. As another example, a prime configuration may establish the required data fields that are stored in association with a particular type of data object. For instance, if a collaborator on a construction project creates a new data object of a given type, such as a request for information (RFI), the RFI may be created with the required data fields established by the prime configuration, such as an RFI number (e.g., expressed in a format that is also established by the prime configuration), an indication of the trade that that request pertains to (e.g., selected from one of the trades established by the prime configuration), a creation date, a requested response date, and so on. Numerous other examples of data fields and data field sets that may be established by a prime configuration are also possible.

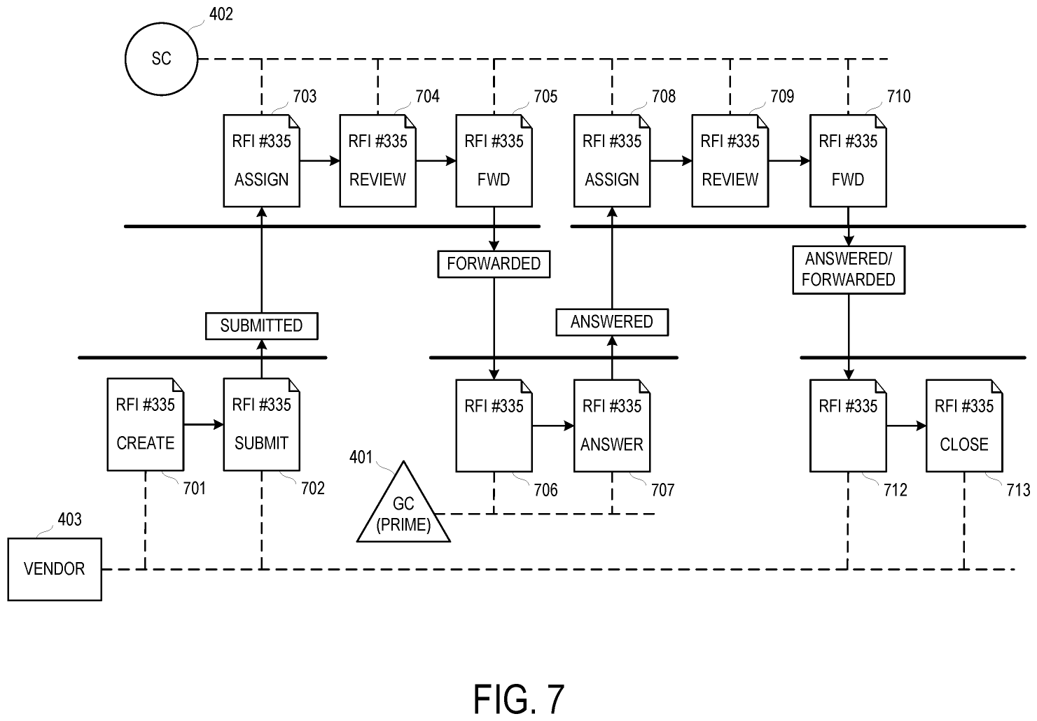

As yet another example, a prime configuration may define a baseline set of logical steps that are to be carried out for a given type of construction project workflow that involves more than one collaborator. Continuing with the RFI example discussed above, a prime configuration may establish a set of steps that are available to resolve the RFI. For instance, a first collaborator may create an RFI and then submit the RFI to a second collaborator. The second collaborator may optionally perform one of several logical steps including (i) answering the RFI, (ii) requesting clarification from the first collaborator, or (iii) forwarding the RFI to a third collaborator for input. A similar set of logical steps may be available to the third collaborator. Eventually, the RFI may be returned to the first collaborator in an answered state, at which point the first collaborator may close the RFI. A more detailed example involving the passing of a data object between collaborators is discussed below with respect to FIG. 7.

Various other types of workflows and associated sets of logical steps involved therewith may be defined by a prime configuration.

In view of the above, it will be appreciated that a prime configuration may establish a consistent way for all collaborators to define and refer to various types of project data, as well as establish a consistent set of expectations for how collaborators may interact with each other in relation to certain types of collaborative workflows, which may reduce confusion or inconsistencies in identifying the certain project data.

However, as noted above, many collaborators desire the flexibility to define and/or refer to certain types of project data in a more customized way, which may allow them to substantially streamline their own internal processes. For instance, as one example, some collaborators may wish to refer to certain types of project data in a way that reflects their respective project-related responsibilities, which may involve a more specific reference than is contemplated by the prime configuration. As another example, collaborators may wish to include certain information or track additional logical workflow steps when creating and/or responding to RFIs, updating project schedule information, tracking budgets, generating invoices, or performing other various tasks with respect to their own project-related responsibilities, which again may be more specific than those established by the prime party. In view of this desire for flexibility, it will be appreciated that, despite some of the benefits discussed above that may be gained from the use of a consistent data schema, the rigid enforcement of a prime configuration with no option for customization may ultimately make a construction project less efficient, as collaborators are forced into using a data schema that does align with their own internal processes. This shortcoming is especially apparent when considering a construction professional that may be involved in multiple different construction projects, each of which may use a different prime configuration, established by a different prime party. In this situation, the problems of data incompatibility discussed above are merely relocated from the construction project to the construction professional's own internal operations.

Accordingly, in another aspect of the disclosed technology, a collaborator may be able to customize certain aspects of project data associated with a construction project by defining their own configurations, referred to herein as “extensions,” that may be added to or otherwise incorporated within the prime configuration, as discussed further below. A collaborator's extensions to the prime configuration may provide additional reference data, data fields, workflow steps, etc. that are useful to the collaborator for performing work on the construction project. Importantly, however, the collaborator's own extensions to the prime configuration may not be visible to the prime party, or to other collaborators to whom the extensions may not be relevant.

To provide this level of flexibility without re-introducing the data compatibility issues noted above, configuration information that is defined within a collaboration hierarchy for a construction project may be inherited by collaborators in only a single direction. In particular, each collaborator will be able to view and utilize their own configurations (e.g., extensions) and those of their upstream collaborators, but will not be able to view and utilize the extensions of downstream collaborators, nor of collaborators to whom they have no link.

This relationship can be seen by way of example with referent to the example hierarchy shown in FIG. 4, which depicts three instances of an example data object as it may be viewed and/or accessed by different collaborators within the hierarchy. In this regard, it should be understood that the three instances of the data object 405a, 405b, and 405c shown in FIG. 4 are intended to represent the same data object (e.g., an RFI, a change order, a work breakdown structure, an invoice, etc.), and are described separately herein based on the different configuration(s) that may be applied, depending on the collaborator.

For example, FIG. 4 shows a data object 405a as it may be viewed and/or accessed by the general contractor 401, which may include configuration information for the construction project (e.g., reference data, particular data fields, etc.) that conforms with the overall data schema established by the prime configuration. The same data object, shown as data object 405b in FIG. 4 as viewed by the subcontractor 402, may include configuration information for the construction project that conforms with the overall data schema established by the prime configuration, plus any extensions to the prime configuration that have been implemented by the subcontractor 402. For example, the data object 405b as viewed by the subcontractor 402 may include additional data fields, more specific information relating to location entities within the construction project, and so on. Notably, these types of extensions are not reflected in the data object 405a as viewed by the general contractor 401. Accordingly, there is no risk that this additional subcontractor-specific information might confuse the general contractor 401 or otherwise result in miscommunications.

Lastly, the same data object is shown again as data object 405c in FIG. 4, as viewed by the vendor 403. In this instance, the data object 405c includes configuration information for the construction project that conforms with the overall data schema established by the prime configuration, plus any extensions to the prime configuration that have been implemented by the subcontractor 402, plus any additional extensions that have been implemented by the vendor 403. As noted above, the vendor's extension(s) are not inherited upstream to the subcontractor 402 or the general contractor 401. Further, although not shown in FIG. 4, to the extent that subcontractor 404 has access to an instance of the data object 405a, it would only include configuration information that conforms with the prime configuration and any extensions added by the subcontractor 404. Neither of the extensions defined by the subcontractor 402 nor the vendor 403 can be accessed by the subcontractor 404, who is not connected to either party.

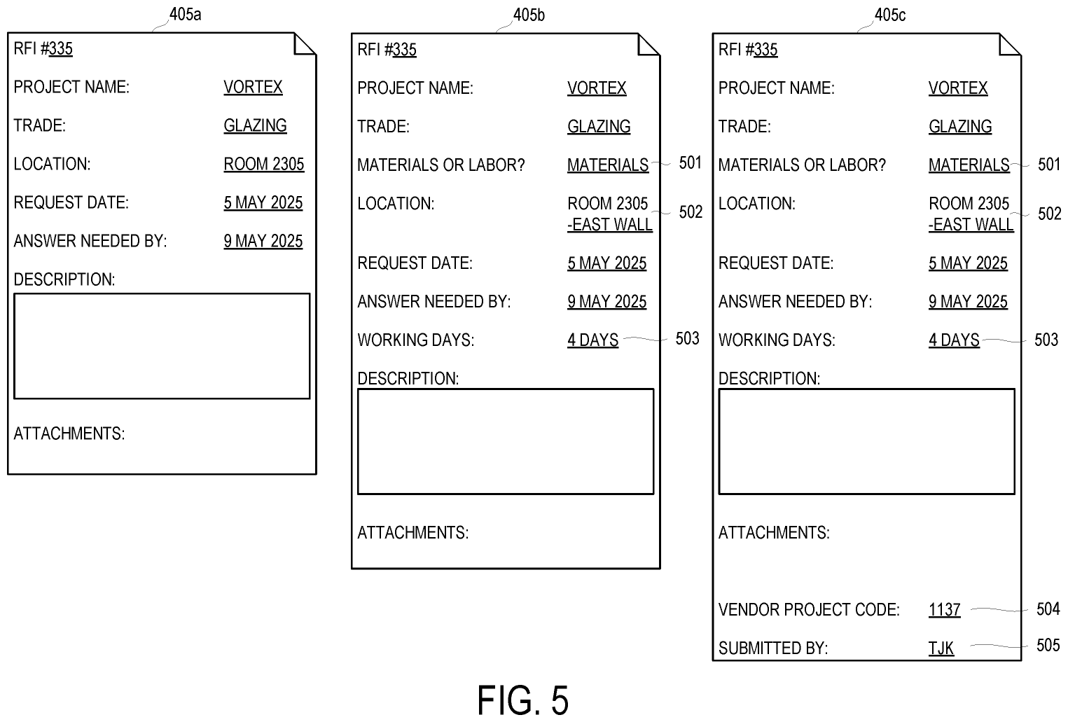

Turning to FIG. 5, one possible example is provided to illustrate the differences in how a data object may be viewed by three different collaborators on a construction project, according to their respective configurations. In particular, FIG. 5 illustrates an example of how the three instances of the data object 405a, 405b, 405c may be viewed by the general contractor 401, the subcontractor 402, and the vendor 403, respectively. In FIG. 5, the data object takes the form of an RFI, although any other type of data object is also possible.

Beginning with the data object 405a as viewed by the general contractor 401, the prime configuration may establish certain data fields that must be included for each RFI that is created for the construction project. These fields include, for example, an RFI number, a project name, a trade that the RFI applies to, a location within the construction project, a request date, an answer needed by date, a description field, and an option to include attachments. Various other fields are also possible. Within the data object 405a, each of these fields established by the prime configuration includes a value. In this regard, the values selected for the individual data fields may also respect the prime configuration. For instance, the prime configuration may define a format for RFI number “335” (e.g., numbered sequentially, in order of creation), the project name “VORTEX” as well as a set of trades involved in the construction project, from which the trade “GLAZING” was selected. In addition, the prime configuration may establish a location entity hierarchy that subdivides the construction project into defined areas that each have a particular name, such as a location entity corresponding to a given room (e.g., within a building to be constructed) that has the name “Room 2305.” Further, the request and answer needed dates may be expressed in a date format that is dictated by the prime configuration.

Turning to the data object 405b, as viewed by the subcontractor 402, the result of several extensions to the prime configuration that were implemented by the subcontractor 402 can be seen. First, the data object 405b includes an additional data field 501 that requires a selection of whether the RFI is related to materials or labor. For instance, the subcontractor 402 may be a glazier, and may prefer to classify every RFI that they are involved with based on whether it involves a request for information related to materials (e.g., glass, window framing, etc.) or labor (e.g., installation) as these two options may involve different departments, crews, people within the glazier's company, and/or additional downstream collaborators, such as the vendor 403.

Second, the data object 405b indicates a more specific location reference 502 as compared to the prime configuration. In this regard, the more specific reference of “Room 2305-East Wall” may provide the subcontractor 402 with more specific information about the location within Room 2305 that is the subject of the RFI. To enable this more specific location reference, the subcontractor 402 may define an extension to the prime configuration that extends the location hierarchy to another, more specific level than that defined by the general contractor 401. For instance, the general contractor's location hierarchy may include a top level location entity for building to be constructed, several sub-location entities corresponding to each floor of the building, followed by several sub-sub location entities corresponding to each room within each floor, each with corresponding names. Although the subcontractor 402 may be unable to alter any of these location entities within the prime configuration, the subcontractor 402 may extend the location entity hierarchy to a more granular level, by sub-dividing individual rooms into further location entities-along with corresponding names—that have significance to the subcontractor 402. Accordingly, when the RFI shown in FIG. 5 is viewed and/or accessed by the subcontractor 402, it displays the location for “Room 2305-East Wall,” but when the same RFI is viewed and/or accessed by the general contractor 401, the location defined by the subcontractor's extension may resolve to the next highest location entity within the prime configuration's location hierarchy, that of Room 2305. Other examples of extensions to a prime configuration location hierarchy are also possible.

Third, the data object 405b includes another additional data field 503 that indicates the number of working days between the date that the RFI was requested and the date by which an answer is needed. As shown in this example, an extension to the prime configuration that may be defined by a collaborator might still be subject to other aspects of the prime configuration. For instance, although the particular data field 503 is not defined in the prime configuration as a data field to be used with RFIs, it nonetheless references a value for which the prime configuration may establish a definition-namely, a number working days. As noted above, the prime configuration may establish how to calculate working days, and thus the value shown in the additional data field 503 may be calculated according to the prime configuration.

Turning to the data object 405c, as viewed by the vendor 403, each of the extensions to the prime configuration that were added by the subcontractor 402 and were viewable by the subcontractor 402 in the data object 405b are also viewable in the data object 405c. This is because, as noted above, the vendor 403 inherited the subcontractor's extensions to the prime configuration along with the prime configuration. Further, as shown in FIG. 5, the data object 405c includes additional extensions defined by the vendor 403 that provide information that is useful to the vendor 403. Specifically, an additional data field 504 for entering a vendor project code and an additional data field 505 for indicating the construction professional (e.g., using initials) who submitted the RFI are provided. In line with the discussion above, these data fields and the values entered for them are only shown in the data object 405c, as viewed by the vendor 403, as these extensions to the prime configuration are not inherited upstream.

Although the examples discussed thus far have involved situations in which extensions to the prime configuration are only inherited in a downstream direction, there may be situations in which a collaborator defines extensions to the prime configuration that are defined as strictly collaborator specific, such that they are not shared downstream or upstream. Further, there may be situations in which an extension to the prime configuration may be proposed for upstream adoption. For instance, with reference the example shown in FIG. 4, the general contractor 401 may decide that the additional data field 503 indicating the number of working days to answer an RFI would be useful to include in the prime configuration, and thus may incorporate the additional data field 503 into the prime configuration such that it is inherited by the general contractor as well as other downstream collaborators of the general contractor 401, such as the subcontractor 404.

In some cases, the upstream adoption (e.g., by the general contractor 401) of an extension to the prime configuration may result in a conflict with how a different downstream collaborator as defined their own extensions to the prime configuration, as it was originally defined. In these situations, a conflict resolution process may be initiated whereby the competing configurations are reconciled.

In still further implementations, a collaborator's extensions to the prime configuration may include a combination of the above approaches. For instance, the collaborator may define certain types of extensions (e.g., extensions involving additional data fields, reference data, etc.) are available to be proposed upstream but other types of extensions (e.g., location hierarchy subdivisions, subcontractor-specific workflows, templates, etc.) are kept private or only inherited downstream.

As yet another possibility, the prime configuration may dictate which parties within a collaboration hierarchy of a construction project are permitted to define extensions to the prime configuration. For example, the prime configuration may indicate that only parties within certain hierarchical tiers (e.g., a second tier including one or more collaborators directly downstream of the general contractor 401, a third tier including one or more collaborators directly downstream of a second tier collaborator, etc.) may define extensions to the prime configuration. As another example, the prime configuration may indicate that any party may define extensions to the prime configuration.

In line with the discussion above, the prime configuration and any extensions to the prime configuration may be maintained by a back-end computing platform that associates such information with each collaborator (e.g., each collaborator user account) in accordance with the discussion above. Accordingly, when a given collaborator that is logged into their user account via an end-user device accesses a given data object of the construction project (e.g., the RFI discussed in relation to FIG. 5), the back-end platform may cause the end-user device to display the data object in accordance with the prime configuration and the appropriate extensions. In this way, the set of configuration options (e.g., the prime configuration and any extensions) associated with a given collaborator user account may act as a sort of lens or filter through which construction project data may be viewed in the way that is most useful to that particular collaborator.

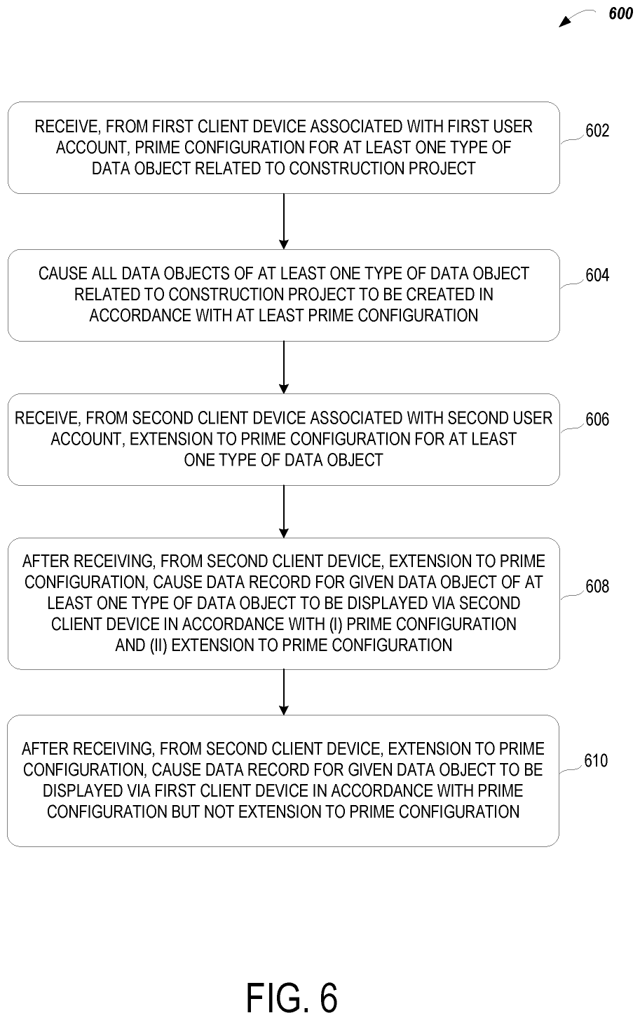

Turning now to FIG. 6, a flowchart 600 is shown that illustrates one example implementation of operations that may be carried out to facilitate collaboration across user accounts as discussed herein. The operations discussed in relation to FIG. 6 may be carried out by a computing platform in communication with a plurality of end-user devices, such as the back-end computing platform 101 in communication with the end-user devices 102-104 shown in FIG. 1, which will be referred to by way of example below. However, it should be understood that any of the operations discussed herein might be carried out by some combination of the back-end computing platform 101 and/or the end-user devices 102-104, or by one of the end-user devices by itself.

Beginning at block 602, the back-end computing platform 101 may receive, from a first end-user device associated with a first user account, a prime configuration for at least one type of data object related to a construction project. For example, the first end-user device may be the end-user device 102 shown in FIG. 1, and the first user account may correspond to the user account of a prime party, such as the general contractor 401 discussed in the previous examples. Further, the at least one type of data object may be an RFI as shown in FIG. 5, although a prime configuration may encompass various other types of data objects as well. As mentioned above, the prime configuration may establish a baseline framework for referring to and/or handling numerous types of data objects that are generated during the course of a construction project.

At block 604, the back-end computing platform 101 may cause all data objects of the at least one type of data object to be created in accordance with at least the prime configuration. As one example, and with reference to FIG. 5, the prime configuration may define, for an RFI type of data object, a given set of data fields that are to be included in an RFI, the set of values that may be selected for one or more the data fields, a set of steps that must be and/or may be carried out to resolve the RFI, and so on. Accordingly, any RFI that is created by any collaborator on the construction project will be created in accordance with these configurations from the prime configuration at a minimum, in addition to any extensions to the prime configuration that were created by and/or inherited by the collaborator.

At block 606, the back-end computing platform 101 may receive, from a second end-user device associated with a second user account, an extension to the prime configuration for the at least one type of data object. For instance, the second end-user device may be the end-user device 103 shown in FIG. 1. Further, as discussed above and shown in relation to FIGS. 4-5, the second user account may correspond to a downstream collaborator of the prime party, such as the subcontractor 402.

In this regard, extensions to the prime configuration may take various forms, several of which are discussed in the examples above. For instance, the prime configuration may include a predefined set of data fields for the at least one type of data object (e.g., an RFI), and the extension to the prime configuration may include at least one additional data field for the RFI, as shown in FIG. 5. In some cases, an extension to the prime configuration that introduces an additional data field may also include a predefined set of additional values (e.g., values that are not otherwise defined within the prime configuration) for the at least one additional data field.

As another example, the prime configuration may include a predefined set of location entities within the construction project and a respective location name for each location entity in the predefined set of location entities. In some cases, as described above, the predefined set of location entities may be defined in a hierarchy where some location entities are nested within other location entities. In this context an extension to the prime configuration may include at least one sub-location entity for a given location entity in the predefined set of location entities and a respective sub-location name for the at least one sub-location entity.

As yet another example, the at least one type of data object may include a workflow and the prime configuration may establish a predefined set of steps that either must be completed or may optionally be completed in order to complete the workflow. In this case, an extension to the prime configuration may include at least one additional predefined step that is added to the workflow, either as a required or an optional step for the collaborator to complete.

Numerous other types of extensions to the prime configuration are also possible, depending on the type of data object.

At block 608, after receiving, from the second end-user device, the extension to the prime configuration, the back-end computing platform 101 may cause a given data object of the at least one type of data object to be displayed via the second end-user device in accordance with (i) the prime configuration and (ii) the extension to the prime configuration. As discussed above, once the prime configuration and the extension to the prime configuration are established, data objects such as the RFI shown in FIG. 5 may be viewed by the subcontractor 402 (e.g., via the end-user device 103 logged into the subcontractor's user account) including all of the configurations and values, etc. that are established by both the prime configuration and the subcontractor's extension to the prime configuration.

On the other hand, at block 610, the back-end computing platform 101 may cause the same data object to be displayed via the first end-user device (e.g., the end-user device 102 logged into the general contractor's user account) in accordance with the prime configuration, but not the extension to the prime configuration, as discussed above.

In the line with the discussion of FIG. 4 and FIG. 5 above, the operations discussed in relation to FIG. 6 may be extended to still further downstream user accounts. For example, the back-end computing platform 101 may receive, from a third end-user device associated with a third user account, a second extension to the prime configuration for the at least one type of data object. In this regard, the third end-user device may be the end-user device 104 shown in FIG. 1, and the third user account may correspond to the vendor 403 shown in FIG. 4. Accordingly, after receiving the first extension and the second extension to the prime configuration, the back-end computing platform 101 may cause the given data object to be displayed via the end-user device 104 in accordance with (i) the prime configuration, (ii) the first extension to the prime configuration, and (iii) the second extension to the prime configuration. However, the back-end computing platform 101 may cause the end-user device 102 and the end-user device 103 to display the given data object to be displayed according the prime configuration and in the case of the end-user device 103, the first extension to the prime configuration, but neither of which according to the second extension to the prime configuration.

Turning now to FIG. 7, an example is provided that depicts one possible workflow for a data object that is created and acted on by three different collaborators on a construction project. In this regard, the new technology discussed herein may be implemented using an even-driven architecture, where the various user accounts involved in the construction project take actions on data objects of the construction project (e.g., creating, consuming, updating, and transmitting data objects) each of which may be treated as an event. For instance, a prime configuration may define a set of workflow steps that are to be carried out to resolve a given data object, such as an RFI. Within the prime configuration, certain steps within the workflow may correspond to an event that signifies a change in control over the data object as it is passed from one collaborator to another for further action. Accordingly, a log of events for a given data object can preserve the history of how the data object was handled. Further, the change in control over the data object may also correspond to a change in configuration settings for how the data object is displayed, and possibly also handled, in line with the discussion above.

Extending the example discussed above, the workflow shown in FIG. 7 corresponds to the creation and resolution of RFI #335, as shown in FIG. 5. Accordingly, the subcontractor 402 may be a glazier responsible for window installation on the construction project, and the vendor 403 may be a company that supplies glass to the subcontractor 402. Further, the prime configuration may define required steps of Create, Submit, Answer, and Close that must be performed in order to resolve the RFI. The prime configuration may also allow a collaborator to optionally Forward an RFI to another collaborator (e.g., a collaborator who is better able to provide an answer) and to optionally Return the RFI to a Submitting or Forwarding collaborator to request clarification.

At step 701, the vendor 403 may cause the RFI to be created, requesting information related to the vendor's work on the project. The back-end computing platform may receive, from the end-user device 104 associated with the vendor's user account, data defining the RFI, and may cause the RFI to be created. For example, the vendor 403 may need clarification on the specifications to be used for the window located at “Room 2305-East Wall” of the construction project. Accordingly, the data object 405c shown in FIG. 5 is created, representing RFI #335. In particular, the RFI is created in accordance with (i) the prime configuration, (ii) the extensions to the prime configuration defined by the subcontractor 402, and (iii) the extensions to the prime configuration defined by the vendor 403.

At step 702, the vendor 403 submits the RFI to the subcontractor 402, which passes control over the RFI from the vendor 403 to the subcontractor 402. For instance, the back-end computing platform 101 may cause a notification to be presented via the end-user device 103, informing the subcontractor 402 that the RFI has been submitted.

In addition to the subcontractor's extensions to the prime configuration discussed above, the subcontractor 402 may also have defined extensions to the prime configuration related to the subcontractor's handling of RFIs. For instance, to better organize and track its internal operations, the subcontractor may have defined an extension to the prime configuration that establishes an Assign step and a Review step that the subcontractor must perform when it receives an RFI from one of its downstream (or upstream) collaborators. Further, the subcontractor may have marked the extension to RFI handling as a private extension, as it does not affect either upstream or downstream collaborators. Accordingly, the extension defining the subcontractor's internal processing of the RFI may be invisible to both the vendor 403 and the general contractor 401.

At step 703, the subcontractor 402 may assign the RFI to a particular user associated with the vendor's user account, who may be assigned to review the RFI. It should be noted that, when the subcontractor 402 is in control of the RFI, the RFI may be displayed as the data object 405b in FIG. 5. Namely, it may be displayed in accordance with the prime configuration and the subcontractor's extensions to the prime configuration, but not the vendor's extensions. The assigned user may review the RFI at step 704 and determine that the vendor 403 is unable to answer the RFI. Rather, the RFI needs to be forwarded to the general contractor 401. Thus, the user may (e.g., via the end-user device 104) forward the RFI to the general contractor 401 at step 705. As above, the back-end platform 101 may facilitate the change in control over the RFI by forwarding it to the general contractor 401.

At step 706, the general contractor 401 may receive the RFI. As noted above, the RFI may now be displayed as the data object 405a shown in FIG. 5, incorporating neither of the extensions of the downstream collaborators. At step 707, the general contractor 401 may update the RFI to include the information requested by the vendor 403 and mark the RFI as answered. The RFI may then transition back to the subcontractor 402 in an Answered state.

At block 708, the subcontractor 402 may receive and assign the RFI as noted above, according to the RFI workflow steps defined by the subcontractor. Accordingly, an assigned user of the subcontractor may review the answered RFI at step 710. For instance, the assigned user may determine that the general contractor's answer is sufficiently detailed. Thereafter, the assigned user may, at step 710, forward the Answered RFI back to the vendor 403, changing control over the RFI once again.

At step 712, the vendor 403 may receive the answered, forwarded RFI and conclude that their request for information has been addressed. The vendor may then close the RFI at step 713, resolving the RFI according to the final required step as defined in the prime configuration.

It should be understood that the example workflow shown in FIG. 7 may be carried out in various other ways, involving more or fewer steps and more or fewer collaborators. Numerous other examples of data objects being collaboratively configured, created, and shared during the course of a construction project are also possible.

FIG. 6 includes one or more operations, functions, or actions as illustrated by one or more of operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowcharts shown in FIG. 6 and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the processes and methods disclosed herein, each block in FIG. 6 may represent circuitry and/or machinery that is wired or arranged to perform the specific functions in the process

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. Claims should not be construed as requiring action by such actors unless explicitly recited in claim language.

1. A computing platform comprising:
at least one network interface;
at least one processor;
at least one non-transitory computer-readable medium; and
program instructions stored on the at least one non-transitory computer-readable medium that are executable by the at least one processor such that the computing platform is configured to:
receive, from a first end-user device associated with a first user account, a prime configuration for at least one type of data object related to a construction project;
cause all data objects of the at least one type of data object related to the construction project to be created in accordance with at least the prime configuration;
receive, from a second end-user device associated with a second user account, an extension to the prime configuration for the at least one type of data object; and
after receiving, from the second end-user device, the extension to the prime configuration:
cause a given data object of the at least one type of data object to be displayed via the second end-user device in accordance with (i) the prime configuration and (ii) the extension to the prime configuration; and
cause the given data object to be displayed via the first end-user device in accordance with the prime configuration but not the extension to the prime configuration.

2. The computing platform of claim 1, wherein the prime configuration comprises a predefined set of data fields for the at least one type of data object, and wherein the extension to the prime configuration comprises at least one additional data field for the at least one type of data object.

3. The computing platform of claim 2, wherein the prime configuration comprises a respective predefined set of values for each data field in the predefined set of data fields for the at least one type of data object, and wherein the extension to the prime configuration comprises a predefined set of additional values for the at least one additional data field.

4. The computing platform of claim 1, wherein the at least one type of data object is a location entity within the construction project, and wherein the prime configuration comprises (i) a predefined set of location entities within the construction project and (ii) a respective location name for each location entity in the predefined set of location entities.

5. The computing platform of claim 4, wherein the extension to the prime configuration comprises (i) at least one sub-location entity for a given location entity in the predefined set of location entities and (ii) a respective sub-location name for the at least one sub-location entity.

6. The computing platform of claim 1, wherein the at least one type of data object is a workflow, and wherein the prime configuration comprises a predefined set of steps to complete the workflow.

7. The computing platform of claim 6, wherein the extension to the prime configuration comprises at least one additional predefined step to complete the workflow.

8. The computing platform of claim 1, wherein the extension is a first extension, the computing platform further comprising program instructions stored on the at least one non-transitory computer-readable medium that are executable by the at least one processor such that the computing platform is configured to:
receive, from a third end-user device associated with a third user account, a second extension to the prime configuration for the at least one type of data object; and
after receiving the first extension and the second extension to the prime configuration:
cause the given data object to be displayed via the third end-user device in accordance with (i) the prime configuration, (ii) the first extension to the prime configuration, and (iii) the second extension to the prime configuration;
cause the given data object to be displayed via the second end-user device in accordance with (i) the prime configuration and (ii) the first extension to the prime configuration but not the second extension to the prime configuration; and
cause the given data object to be displayed via the first end-user device in accordance with the prime configuration but not the first extension or the second extension to the prime configuration.

9. A non-transitory computer-readable medium, wherein the non-transitory computer-readable medium is provisioned with program instructions that, when executed by at least one processor, cause a computing platform to:
receive, from a first end-user device associated with a first user account, a prime configuration for at least one type of data object related to a construction project;
cause all data objects of the at least one type of data object related to the construction project to be created in accordance with at least the prime configuration;
receive, from a second end-user device associated with a second user account, an extension to the prime configuration for the at least one type of data object; and
after receiving, from the second end-user device, the extension to the prime configuration:
cause a given data object of the at least one type of data object to be displayed via the second end-user device in accordance with (i) the prime configuration and (ii) the extension to the prime configuration; and
cause the given data object to be displayed via the first end-user device in accordance with the prime configuration but not the extension to the prime configuration.

10. The non-transitory computer-readable medium of claim 9, wherein the prime configuration comprises a predefined set of data fields for the at least one type of data object, and wherein the extension to the prime configuration comprises at least one additional data field for the at least one type of data object.

11. The non-transitory computer-readable medium of claim 10, wherein the prime configuration comprises a respective predefined set of values for each data field in the predefined set of data fields for the at least one type of data object, and wherein the extension to the prime configuration comprises a predefined set of additional values for the at least one additional data field.

12. The non-transitory computer-readable medium of claim 9, wherein the at least one type of data object is a location entity within the construction project, and wherein the prime configuration comprises (i) a predefined set of location entities within the construction project and (ii) a respective location name for each location entity in the predefined set of location entities.

13. The non-transitory computer-readable medium of claim 12, wherein the extension to the prime configuration comprises (i) at least one sub-location entity for a given location entity in the predefined set of location entities and (ii) a respective sub-location name for the at least one sub-location entity.

14. The computing platform of claim 9, wherein the at least one type of data object is a workflow, and wherein the prime configuration comprises a predefined set of steps to complete the workflow.

15. The non-transitory computer-readable medium of claim 14, wherein the extension to the prime configuration comprises at least one additional predefined step to complete the workflow.

16. The non-transitory computer-readable medium of claim 9, wherein the extension is a first extension, and wherein the non-transitory computer-readable medium is also provisioned with program instructions that, when executed by at least one processor, cause the computing platform to:
receive, from a third end-user device associated with a third user account, a second extension to the prime configuration for the at least one type of data object; and
after receiving the first extension and the second extension to the prime configuration:
cause the given data object to be displayed via the third end-user device in accordance with (i) the prime configuration, (ii) the first extension to the prime configuration, and (iii) the second extension to the prime configuration;
cause the given data object to be displayed via the second end-user device in accordance with (i) the prime configuration and (ii) the first extension to the prime configuration but not the second extension to the prime configuration; and
cause the given data object to be displayed via the first end-user device in accordance with the prime configuration but not the first extension or the second extension to the prime configuration.

17. A method carried out by a computing platform, the method comprising:
receiving, from a first end-user device associated with a first user account, a prime configuration for at least one type of data object related to a construction project;
causing all data objects of the at least one type of data object related to the construction project to be created in accordance with at least the prime configuration;
receiving, from a second end-user device associated with a second user account, an extension to the prime configuration for the at least one type of data object; and
after receiving, from the second end-user device, the extension to the prime configuration:
causing a given data object of the at least one type of data object to be displayed via the second end-user device in accordance with (i) the prime configuration and (ii) the extension to the prime configuration; and
causing the given data object to be displayed via the first end-user device in accordance with the prime configuration but not the extension to the prime configuration.

18. The method of claim 17, wherein the prime configuration comprises (i) a predefined set of data fields for the at least one type of data object and (ii) a respective predefined set of values for each data field in the predefined set of data fields for the at least one type of data object, and wherein the extension to the prime configuration comprises (i) at least one additional data field for the at least one type of data object and (ii) a predefined set of additional values for the at least one additional data field.

19. The method of claim 17, wherein the at least one type of data object is a location entity within the construction project, wherein the prime configuration comprises (i) a predefined set of location entities within the construction project and (ii) a respective location name for each location entity in the predefined set of location entities, and wherein the extension to the prime configuration comprises (i) at least one sub-location entity for a given location entity in the predefined set of location entities and (ii) a respective sub-location name for the at least one sub-location entity.

20. The method of claim 17, wherein the extension is a first extension, the method further comprising:
receiving, from a third end-user device associated with a third user account, a second extension to the prime configuration for the at least one type of data object; and
after receiving the first extension and the second extension to the prime configuration:
causing the given data object to be displayed via the third end-user device in accordance with (i) the prime configuration, (ii) the first extension to the prime configuration, and (iii) the second extension to the prime configuration;
causing the given data object to be displayed via the second end-user device in accordance with (i) the prime configuration and (ii) the first extension to the prime configuration but not the second extension to the prime configuration; and
causing the given data object to be displayed via the first end-user device in accordance with the prime configuration but not the first extension or the second extension to the prime configuration.
